(19) United States
(12) Patent Application Publication
(10) Pub. No.: US 2005/0273419 A1
(43) Pub. Date: Dec. 8, 2005

(54) Method for executing block orders of commodities

(75) Inventors: David Ogg, Warren, NJ (US); Mark Smith, Saint Petersburg, FL (US)

Correspondence Address: DAVIDSON, DAVIDSON & KAPPEL, LLC, 485 SEVENTH AVENUE, 14TH FLOOR, NEW YORK, NY, 10018, US

(73) Assignee: Lava Trading Inc., New York, NY (US)

(21) Appl. No.: 10/863,552

(22) Filed: Jun. 8, 2004

(51) Int. Cl. G06F 17/60

(52) U.S. Cl. 705/37; 705/42

(57) ABSTRACT

According to one exemplary embodiment of the present invention, a computerized method for routing orders relating to a commodity block trade is provided. The computerized method for routing orders relating to a commodity block trade includes a process for receiving a block trade for X amount of a commodity, and dividing the block trade into n equal orders. Pursuant to a feature of the present invention, each order is for an amount equal to 1/n times X, where n is a number of liquidity providers for the commodity. N liquidity providers are provided, and the n orders are distributed, one to each of the n liquidity providers. Moreover, information regarding the block order, including the amount X, is distributed to each of the n liquidity providers.

### BACKGROUND OF THE INVENTION

There has long been a need for established markets for the buying and selling of various commodities, such as, for example, the currencies of foreign countries, referred to as foreign exchange. A typical foreign exchange situation would be where a business in the United States having cash deposits denominated in dollars, and desiring to purchase a commodity in France, would have to acquire Euros in order to complete the purchase transaction. Or, the French merchant selling the commodity, could decide to accept payment for the commodity in dollars, but would want to use the dollars to purchase Euros for deposit in its account in a French bank.

Historically, banks have been major market makers for foreign exchange. They are the principal source of liquidity for foreign exchange transactions. A customer, such as the treasurer of a multinational corporation, wanting to engage in a foreign exchange transaction to obtain, for example, Japanese yen, would call his or her bank to place a Request For Quote (RFQ). The customer would have a credit rating at the bank, and depending upon such factors as the customer's credit rating, the volume of the transaction, how good a customer the treasurer is to the bank, and so on, the bank would provide a quote to the customer. In this case, for example, the quote would be a yen per dollar figure.

The bank would typically be a member of one or more established, bank-member-only foreign exchange markets. These foreign exchange markets are referred to as sell-side foreign exchange markets because the trading members are typically solely banks and other providers of liquidity to the market. Examples of such sell-side foreign exchange markets are EBS and the foreign exchange market maintained for banks and other liquidity providers by Reuters. The bank would base its customer quote on the current pricing for the desired currency in the sell-side foreign exchange market, and may include a mark-up on the current price to insure a profit for the bank.

Sophisticated customers often call several banks to place RFQ's, and thereby obtain several quotes to assure access to the best and fairest price available for his or her foreign exchange transaction. A problem associated with the submission of RFQ's to several different banks is the phenomena known as “the winner's curse.” For example, in the event a customer wants to exchange a large amount of currency, an amount that would most likely affect prices in the foreign exchange market, the banks that receive an RFQ, but do not get the order, now have knowledge of a large order that is set for imminent placement. Traders at such banks often take advantage of this information to trade based upon the information, and secure profits when the anticipated large order is eventually placed. The bank that received the order, on the other hand, must actually engage in the large block trade for the customer. Such a phenomena can occur with respect to any block trade of any commodity, when the amount involved is sufficient to affect market prices.

### SUMMARY OF THE INVENTION

In accordance with a first embodiment of the present invention, a computerized method for routing orders for a commodity block trade is provided. The computerized method for routing orders relating to a commodity block trade includes a process for receiving a block trade for X amount of a commodity, and dividing the block trade into n equal orders. Pursuant to a feature of the present invention, each order is for an amount equal to 1/n times X, where n is a number of liquidity providers for the commodity. N liquidity providers are provided, and the n orders are distributed, one to each of the n liquidity providers. Moreover, information regarding the block order, including the amount X, is distributed to each of the n liquidity providers.

In one preferred embodiment of the present invention, the commodity block trade is a foreign exchange block trade.

In accordance with a second embodiment of the present invention, a computerized method for routing orders for a commodity block trade is provided. The computerized method for routing orders relating to a commodity block trade includes a process for providing a commodity block trade processing interface, and coupling the commodity block trade processing interface to each of a plurality of liquidity providers for the commodity, and a plurality of customer/traders. According to a feature of the present invention, the block trade processing interface is operated to receive a block order for X amount, from one of the plurality of customer/traders. Further steps of the process include operating the commodity block trade processing interface to divide the block trade into n equal orders, each order for an amount equal to 1/n times X, where n is a number of liquidity providers for the commodity in the plurality of liquidity providers, operating the commodity block trade processing interface to distribute the n orders, one to each of the n liquidity providers, and operating the commodity block trade processing interface to distribute information regarding the block order, including the amount X, to each of the n liquidity providers.

In accordance with a third embodiment of the present invention, a computerized method for routing orders for a commodity block trade is provided. The computerized method for routing orders relating to a commodity block trade includes a process for receiving a block trade for X amount of a commodity, and dividing the block trade into n orders, each one of the n orders being of an amount equal to a preselected percentage of X, where n corresponds to a number of liquidity providers for the commodity. Pursuant to a feature of the present invention, n liquidity providers are provided, each corresponding to one of the preselected percentages of X of the n orders. The n orders are distributed, one to each of the n liquidity providers according to the corresponding preselected percentage of X. Moreover, information regarding the block order, including the amount X, is distributed to each of the n liquidity providers.

In accordance with a fourth embodiment of the present invention, a computer device for routing orders relating to a commodity block trade is provided. The computer device includes a commodity block trade processing interface arranged and configured to be coupled to each of a plurality of liquidity providers for the commodity, and a plurality of customer/traders. The commodity block trade processing interface operates to receive a block order for X amount of the commodity, from one of the plurality of customer/traders. Pursuant to a feature of the present invention, the commodity block trade processing interface further operates to divide the block trade into n orders, each one of the n orders being of an amount equal to a preselected percentage of X, where n corresponds to a number of liquidity providers for the commodity coupled to the commodity block trade processing interface, with each of the n liquidity providers corresponding to a preselected percentage of X. The commodity block trade processing interface operates to distribute the n orders, one to each of the n liquidity providers according to the corresponding preselected percentage of X, and distributes information regarding the block order, including the amount X, to each of the n liquidity providers.

### BRIEF DESCRIPTION OF THE DRAWINGS

FIG. 1 is a block diagram of an exemplary system that can be used to implement embodiments of the present invention.

FIG. 2 shows an illustrative flow chart for implementing a block trading process, according to a feature of the present invention.

### DETAILED DESCRIPTION OF THE PREFERRED EMBODIMENTS

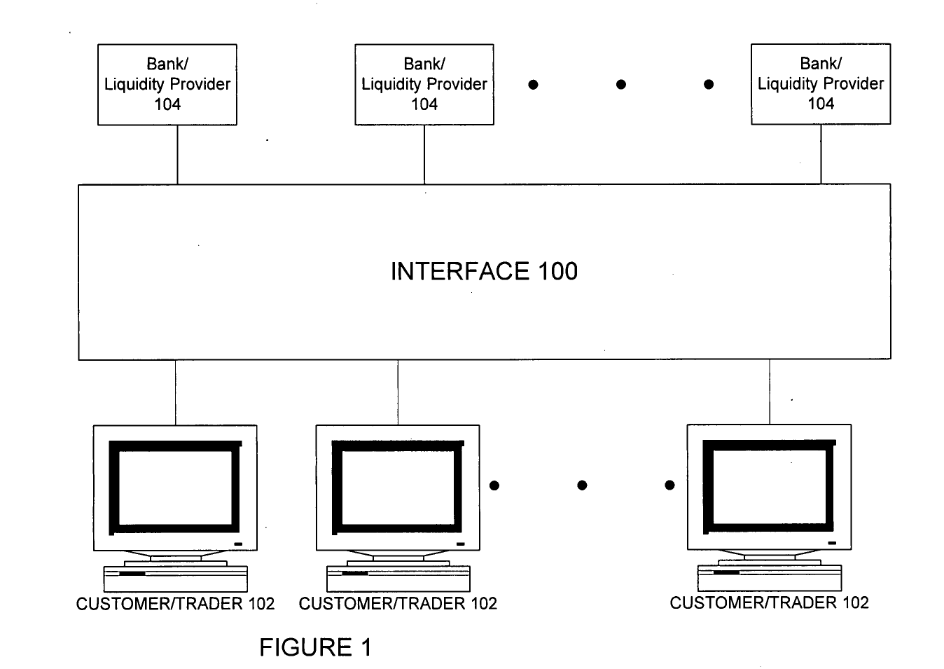

Referring now to the drawings, and initially to FIG. 1, there is illustrated a block diagram of an automated system for routing orders and information relating to commodity block trades, for example block trades for foreign exchange transactions. In accordance with an exemplary of the present invention, a commodity block trade processing interface 100, comprising, for example, a computer, is arranged to be coupled to each of a plurality of customer/traders 102, and to each of a plurality of liquidity providers 104. The liquidity providers 104 can comprise banks, other financial institutions, and/or other clients or customers. In this exemplary embodiment of the present invention, the interface 100 is arranged to process foreign exchanges transactions including block trades of foreign exchange. The block trading interface 100 can operate to process block trades of any other commodity or financial instruments, including equities.

In this exemplary embodiment of the present invention, each of the bank/liquidity providers 104 is a financial institution that engages in foreign exchange. Each of the bank/liquidity providers 104 is a market maker in foreign exchange and can be operated to provide a price feed to various customer/traders 102 via the interface 100. The price feed comprises both bid and asking prices for each currency traded by the bank/liquidity provider 104. This is because, as a market maker, the institution is prepared to both buy and sell each currency traded by the bank/liquidity provider 104. In this manner, the institution is a provider of liquidity to the customer/traders 102. Each of the bank/liquidity providers 104 is electronically coupled to the interface 100 by, for example, a computer, to transmit and receive foreign exchange order information to and from the various customer/traders 102 coupled to the interface 100. In the alternative, each of the bank/liquidity providers can be indirectly coupled to the interface 100, through, for example, a multi-bank portal, as are known in the art.

Each of the customer/traders 102 has a credit rating either with each of the plurality of bank/liquidity providers 104, or with one or more bank/liquidity provider(s) 104 which act as prime broker(s) for the particular customer/trader 102. An innovation in the foreign exchange market is the use of a “prime brokerage” account. Rather than set up a credit rating at each of several banks, as, for example, at each of the bank/liquidity providers 104 coupled to the interface 100, a customer/trader 102 can establish a credit rating at one or more selected bank/liquidity providers 104, that then acts as a prime broker in all transactions for that customer/trader 102. This, in effect, places the prime broker bank(s) as a representative for the credit of the particular customer/trader 102, to the rest of the bank/liquidity providers 104.

Each of the customer/traders 102 is electronically coupled to the commodity block trade processing interface 100 by, for example, a desk top computer. Each of the customer/traders 102, via the respective desk top computer, is arranged to transmit and receive foreign exchange order information to and from the various bank/liquidity providers 104 via the interface 100. The order information transmitted by the customer/traders 102 may comprise, for example, a bid price and quantity for the purchase of a particular desired foreign currency (a buy order), or an asking price and quantity for the sale of the currency (a sell order).

In certain instances, the buy or sell order may be a block order, which for the purposes of the present invention, comprises an order of a size that is sufficiently large to affect prices in the foreign exchange market. A block trade can be defined, for example, as a trade worth $50 million dollars or more. In the event of a block order, the particular customer/trader 102 can elect to enter a “Block Trade” routine to have the commodity block trade processing interface 100 process the large order in accordance with a feature of the present invention, as will be described. Pursuant to the present invention, each of the bank/liquidity providers 104 agrees to accept a fixed percentage amount of any block order placed by any of the customer/traders 102 as a market price trade. The agreement can be made subject to certain conditions, such as a minimum amount for a block trade, for example, the $50 million dollar amount discussed above, time of day limitations, the number of liquidity providers that will accept the fixed percentage trades, and so on. In return for the agreement to accept the fixed percentage trade, each of the bank/liquidity providers 104 receives trade information regarding the total amount of the trade. In this manner, each bank/liquidity provider 104 has a limited “winner's curse” liability, and has market knowledge that can be utilized to engage in profitable foreign exchange trading.

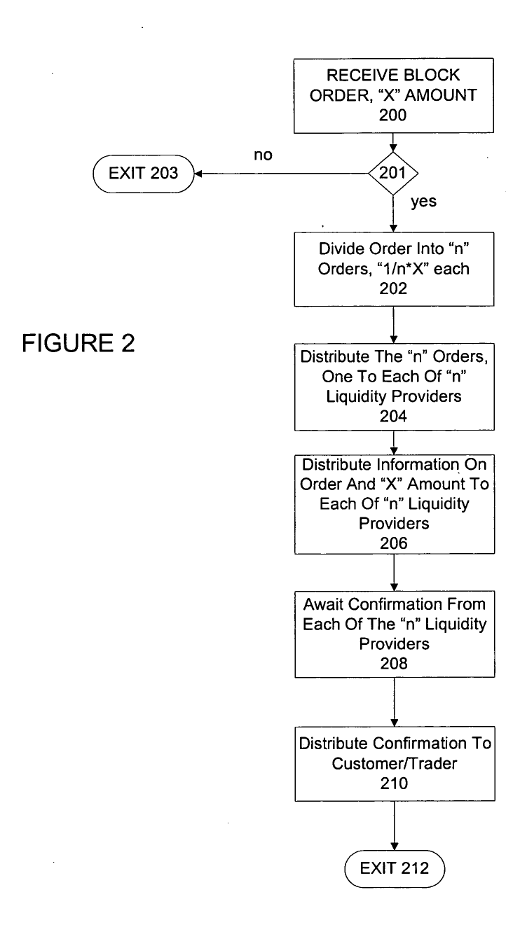

Referring now to FIG. 2, there is illustrated a flow chart for implementing the block trading process, according to a feature of the present invention. In step 200, the commodity block trade processing interface 100 receives a block trade order from one of the customer/traders 102, who has specified that the order is to be processed according to the Block Trade routine. The block trade includes an amount X, which must be equal to or more than an agreed upon minimum, such as our example of $50 million.

At this time the commodity block trade processing interface 100 can perform credit and/or margin checking procedures against the customer/trader 102 who has submitted the block trade, as may be required in foreign exchange transactions. The procedure can determine whether the customer/trader 102 has a prime broker relationship or sufficient credit in its own right, and execute the trade accordingly. The procedure can also include an automatic analysis of the current positions of the customer/trader 102, and a calculation of exposure due to the proposed trade, for example, using a known exposure calculation method. The analysis can also include a calculation of margin available to the customer/trader 102.

In the event that the customer/trader 102 does not pass the credit or margin check, in step 201, the interface 100 will exit the block trade routine (step 203). In the event that the customer/trader 102 passes the credit or margin check, the interface 100 proceeds to step 202.

In step 202, the commodity block trade processing interface 100 operates to divide the block order into n orders, where n equals the total number of bank/liquidity providers 104 coupled to the interface 100, and participating in the block trade routine. For example, if there are 50 bank/liquidity providers 104, the interface 100 will generate 50 orders. Each of the orders will be in the amount of 1/n times X, where X is the total amount specified in the block order, as noted above. In our example of 50 bank/liquidity providers 104, and in the case of a block order for $50 million dollars of Euros, each order will be for $1,000,000 worth of Euros.

In step 204, the commodity block trade processing interface 100 operates to electronically distribute the n orders to the n bank/liquidity providers 104, one to each of the bank/liquidity providers 104. Thus, each bank/liquidity provider 104 receives, in our example, an order to purchase $1,000,000 worth of Euros, to be executed at the market price, or at a preselected price spread around the current market price.

In step 206, the commodity block trade processing interface 100 operates to electronically distribute information regarding the block order, and X, the amount of the order, to each of the n bank/liquidity providers 104. Thus, as noted above, each of the bank/liquidity providers 104 obtains market information which can be used for trading.

Subsequent to distribution of the n orders, in step 208, the commodity block trade processing interface 100 awaits electronic confirmation of execution of the orders from each of the n bank/liquidity providers 104. Upon receipt of confirmations from all of the n bank/liquidity providers 104, the commodity block trade processing interface 100 transmits a confirmation to the customer/trader 100 who initiated the block trade.

In step 212, the commodity block trade processing interface 100 exits the block trade routine.

Thus, in accordance with the present invention, no single liquidity provider must endure a “winner's curse” for executing a large block order. The risks and liabilities are divided among a group of n liquidity providers where n is a number that is sufficient in number to minimize the risk, in our example, 50 bank/liquidity providers 104. Yet, the distribution of block trade amount information permits each of the participating bank/liquidity providers 104 to more than offset the market risk assumed due to the block trade routine participation, by allowing trading profits to be realized due to the knowledge of the total market impact of the X amount block trade. As discussed above, the X amount is an amount that will likely affect market prices.

In accordance with another embodiment of the present invention, one or more specific bank/liquidity providers 104 may desire to accept a fixed percentage amount of the X amount block order placed by a customer/trader 102, that is, for example, greater than 1/n times X. In such an instance, the interface 100 will generate n orders, as in the previously described embodiment of the present invention, but the amount of each order will vary according to specific amounts selected by the n participating bank/liquidity providers 104. The interface 100 is operated to divide the block trade into n orders, each one of the n orders being of an amount equal to a preselected percentage of X, as selected by a corresponding one of the bank/liquidity providers 104. The total of all the selected percentages will equal 100% of the X amount, and each percentage selected by a particular bank/liquidity provider 104 will be sufficiently small to minimize the impact of the trade on the market price.

In the preceding specification, the invention has been described with reference to specific exemplary embodiments and examples thereof. It will, however, be evident that various modifications and changes may be made thereto without departing from the broader spirit and scope of the invention as set forth in the claims that follow. The specification and drawings are accordingly to be regarded in an illustrative manner rather than a restrictive sense.

1. A computerized method for routing orders relating to a commodity block trade, comprising the steps of:
(a) receiving a block trade for X amount of a commodity;
(b) dividing the block trade into n equal orders, each order for an amount equal to 1/n times X, where n is a number of liquidity providers for the commodity;
(c) providing n liquidity providers;
(d) distributing the n orders, one to each of the n liquidity providers; and
(e) distributing information regarding the block order, including the amount X, to each of the n liquidity providers.

2. The computerized method of claim 1, wherein the commodity is foreign exchange.

3. The computerized method of claim 1, wherein the commodity comprises equities.

4. The computerized method of claim 1, wherein the liquidity providers comprise banks.

5. The computerized method of claim 1, wherein the liquidity providers comprise financial institutions.

6. The computerized method of claim 1, wherein the amount X is at least equal to a preselected minium.

7. The computerized method of claim 1, wherein n is at least a preselected minimum amount.

8. A computerized method for routing orders relating to a commodity block trade, comprising the steps of:
(a) providing a commodity block trade processing interface;
(b) coupling the commodity block trade processing interface to each of a plurality of liquidity providers for the commodity, and a plurality of customer/traders;
(c) receiving at the commodity block trade processing interface, a block order for X amount, from one of the plurality of customer/traders;
(d) operating the commodity block trade processing interface to divide the block trade into n equal orders, each order for an amount equal to 1/n times x, where n is a number of liquidity providers for the commodity in the plurality of liquidity providers;
(e) operating the commodity block trade processing interface to distribute the n orders, one to each of the n liquidity providers; and
(f) operating the commodity block trade processing interface to distribute information regarding the block order, including the amount X, to each of the n liquidity providers.

9. The computerized method of claim 8 wherein the block trade is a block trade for foreign exchange.

10. The computerized method of claim 8 wherein the block trade is a block trade for a commodity.

11. The computerized method of claim 8 wherein the liquidity providers comprise banks.

12. The computerized method of claim 8 wherein the liquidity providers comprise financial institutions.

13. The computerized method of claim 8 comprising the further steps of operating the commodity block trade processing interface to await order confirmations from each of the n liquidity providers, and to distribute an order confirmation to the one of the plurality of customer/traders upon receipt of the order confirmations from each of the n liquidity providers.

14. A computerized method for routing orders relating to a commodity block trade, comprising the steps of:
(a) receiving a block trade for X amount of a commodity;
(b) dividing the block trade into n orders, each one of the n orders being of an amount equal to a preselected percentage of X, where n corresponds to a number of liquidity providers for the commodity;
(c) providing n liquidity providers, each corresponding to one of the preselected percentages of X of the n orders;
(d) distributing the n orders, one to each of the n liquidity providers according to the corresponding preselected percentage of X; and
(e) distributing information regarding the block order, including the amount X, to each of the n liquidity providers.

15. The computerized method of claim 14, wherein the commodity is foreign exchange.

16. The computerized method of claim 14, wherein the liquidity providers comprise banks.

17. The computerized method of claim 14, wherein the commodity comprises equities.

18. The computerized method of claim 14, wherein the liquidity providers comprise financial institutions.

19. The computerized method of claim 14, wherein the amount X is at least equal to a preselected minium.

20. A computer device for routing orders relating to a commodity block trade, comprising:
(a) a commodity block trade processing interface arranged and configured to be coupled to each of a plurality of liquidity providers for the commodity, and a plurality of customer/traders;
(b) the commodity block trade processing interface operating to receive a block order for X amount of the commodity, from one of the plurality of customer/traders;
(c) the commodity block trade processing interface operating to divide the block trade into n orders, each one of the n orders being of an amount equal to a preselected percentage of X, where n corresponds to a number of liquidity providers for the commodity coupled to the commodity block trade processing interface, each of the n liquidity providers corresponding to a preselected percentage of X;
(d) the commodity block trade processing interface operating to distribute the n orders, one to each of the n liquidity providers according to the corresponding preselected percentage of X; and
(e) the commodity block trade processing interface operating to distribute information regarding the block order, including the amount X, to each of the n liquidity providers.

21. The computer device of claim 20, wherein the commodity is foreign exchange.

22. The computer device of claim 20, wherein the commodity comprises equities.

23. The computer device of claim 20, wherein the amount X is at least equal to a preselected minium.

24. The computer device of claim 20, wherein n is at least a preselected minimum amount.

25. The computer device of claim 20, wherein the amount of each of the n orders is equal to 1/n times X.

26. The computerized method of claim 14, wherein the liquidity providers comprise clients.
